(19) United States
(12) Patent Application Publication
(10) Pub. No.: US 2007/0136141 A1
(43) Pub. Date: Jun. 14, 2007

(54) System and method that provides for trading monetary, goods, or services

(76) Inventor: Su Van Nguyen, Hayward, CA (US)

Correspondence Address: Su Van Nguyen, 29853 Vanderbilt St. D, Hayward, CA, 94544, US

(21) Appl. No.: 11/340,898

(22) Filed: Jan. 27, 2006

Related U.S. Application Data
(60) Provisional application No. 60/748,709, filed on Dec. 9, 2005.

(51) Int. Cl. G06Q 30/00

(52) U.S. Cl. 705/26

(57) ABSTRACT

A system and method that includes web server or a newspaper ad that allows people to trade their monetary, goods or services for someone else monetary, goods, or services by depositing the variable value of the monetary, goods, or services into a Deposit Bank. A method comprise of a posting on to the system, the posting requires a entity monetary, goods, or services willing to exchange for another entity monetary, goods, or services. The monetary value is then deposited into the system or hold by the system, owner or third party, Deposit Bank. The two entities will deliver monetary, goods, or services as agreed. The monetary value is then returned to both entities.

### RELATED APPLICATIONS

The present application is a continuation-in-part application of U.S. provisional patent application, Ser. No. US60/748,709, filed Dec. 9, 2005, for SYSTEM AND METHOD PROVIDES FOR TRADING PRODUCTS AND SERVICES, by Su Van Nguyen, included by reference herein and for which benefit of the priority date is hereby claimed.

### FIELD OF THE INVENTION

This invention relates generally to the field of apparatus for a system and method that provides for trading monetary, goods, or services. Moreover it pertains specifically to such system and method that provides for trading monetary, goods, or services, by means allowing people to trade their monetary, goods, or services with the others monetary, goods, or services.

### BACKGROUND OF THE INVENTION

People buy or sell stuff through the Internet or through newspaper ads. Sometimes, what happens is that buyer pays for the product but seller did not deliver the product. It could also happen the other way around. The person therefore gets frustrated. Another example would be trading products through the Internet or through the newspaper where one delivers but the other did not. The Internet and newspaper are just examples, it could also be TV or radio.

Accordingly several advantages and objects of the present invention are:

A principal object of the present invention is to provide a system and method that provides for trading monetary, goods, or services that will overcome the deficiencies of the prior art systems and methods.

An object of the present invention is to provide a system and method that provides for trading monetary, goods, or services for people to trade in a secure way by depositing variable value.

Another object of the present invention is to provide system and method that provides for trading monetary, goods, or services for people to trade local, national, or international.

Another object of the present invention is to provide a system and method that provides for trading monetary, goods, or services for people to get what they want for what they have to offer through the system

Another object of the present invention is to provide a system and method that provides for trading monetary, goods, or services that a Deposit Bank is created which is a place, account, bank, or the like.

Another object of the present invention is to provide a system and method that provides for trading monetary, goods, or services that the value of money of the monetary, goods, or services is determined either by the poster or the replier.

Another object of the present invention is to provide a system and method that provides for trading monetary, goods, or services that the Deposit Bank releases the money back to the poster and replier once consent is received.

Another object of the present invention is to provide a system and method that provides for trading monetary, goods, or services that allows people to trade their monetary, good or service confidently that it is safe to deliver.

Another object of the present invention is to provide system and method that provides for trading monetary, goods, or services that is more universally functional in today's market than any prior art system.

It is intended that any other advantages and objects of the present invention that become apparent or obvious from the detailed description or illustrations contained herein are within the scope of the present invention.

### SUMMARY OF THE INVENTION

In view of the limitations now present in the prior art, the present invention provides a new and useful system and method that provides for trading monetary, goods, or services which is simpler in construction, more universally usable and more versatile in operation than known system and method of this kind.

The purpose of the present invention is to provide a new system and method that provides for trading monetary, goods or services that has many novel features not offered by the prior art system and method that result in a new system and method that provides for trading monetary, goods, or services which is not apparent, obvious, or suggested, either directly or indirectly by any of the prior art system and method

The present invention generally comprises of a system electronic or paper where by a person, First Trader, willing to post monetary, goods or services they would provide for another person, Second Trader, monetary, goods, or services. The First Trader would post his or her monetary, goods, or services and also post his or her wanted monetary, goods or services in exchange for. The Second Trader who visits this electronic or ad, local or international, system finds the posting, will post a reply to this post and say yes he or she have the monetary, goods, or services wanted. The First Trader then replies to this message if he or she agrees for a trade. Then Second Trader will choose a value for the monetary, goods, or services as a deposit to the system. The Second Trader then deposits the monetary and the First Trader also deposit the monetary in form of check, money order, credit card, or any valid payment type in the system. Once the monetary or hold is received from both ends. The Second Trader ships or delivers his or her monetary, goods, or services out to the First Trader. Also the First Trader ships or delivers his or her monetary, goods, or services to the Second Trader. The monetary deposited is return to both traders some transaction fees may or may not apply.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a front view of a system and method that provides for trading of monetary, goods, or services according to the present invention.

FIG. 2, 3, 4, 5 illustrates an example of a system and method that provides for trading of monetary, goods, or services according to the present invention to be conducted confidently.

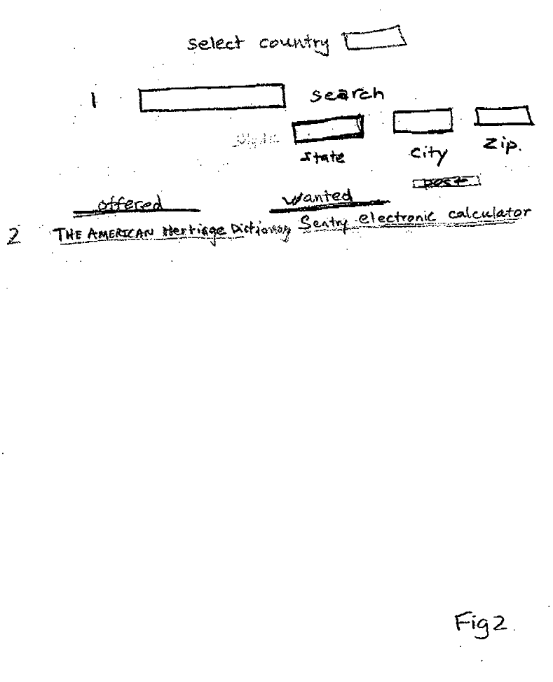

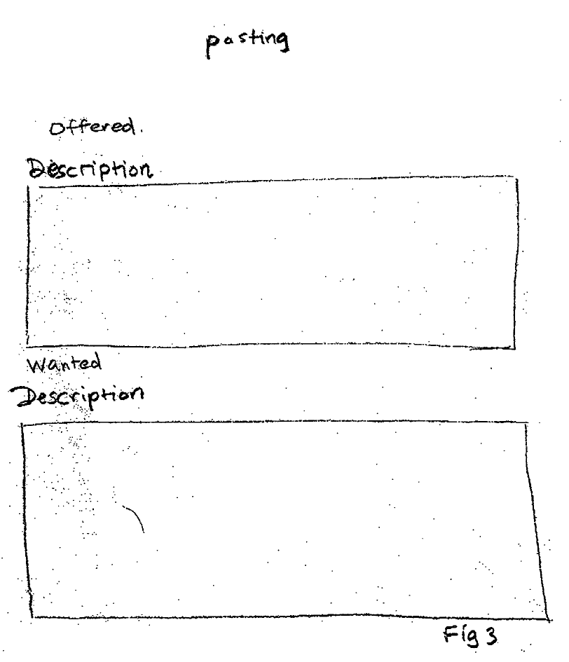

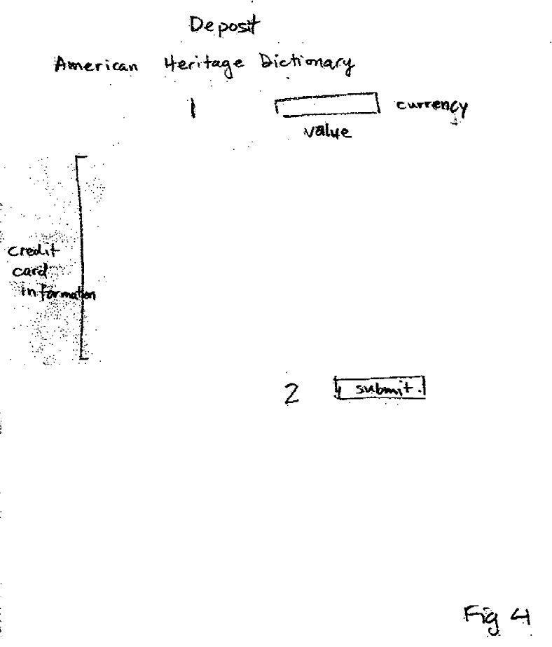

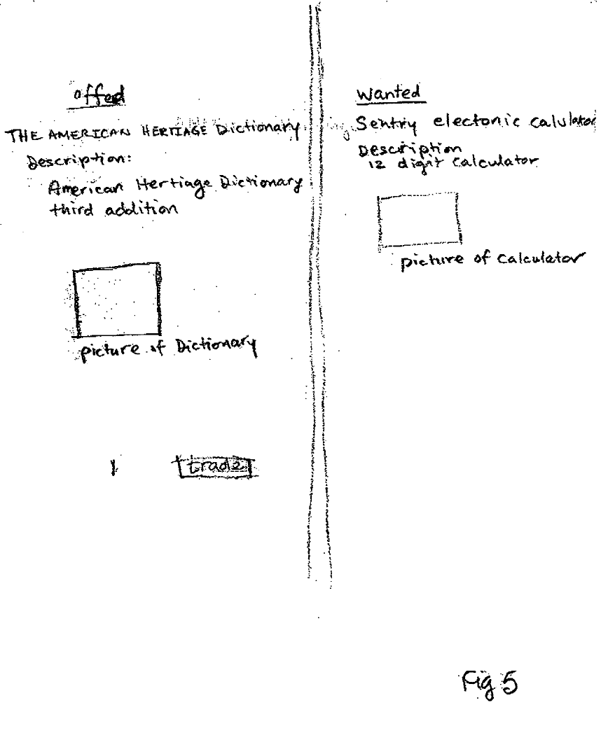

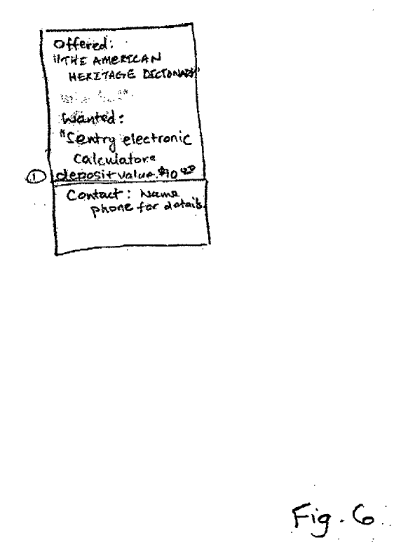

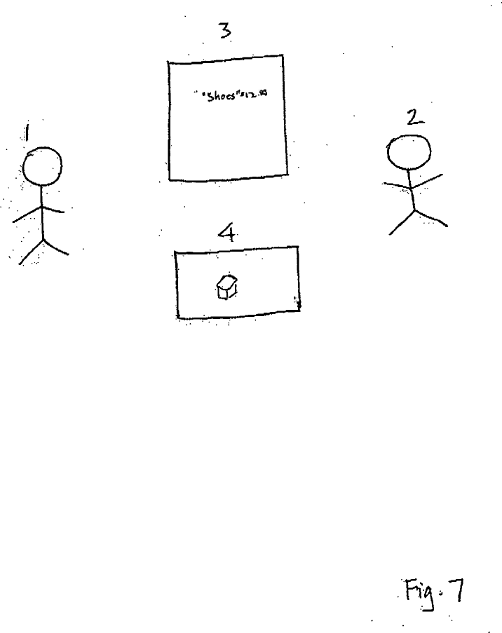

The present example comprise of a front-page FIG. 2. FIG. 2 has a “post” linked to FIG. 3 allows the First Trader to post information regarding the what is offered and what is wanted. Going back to FIG. 2 again the Second Trader type in a search 1 for “american heritage” and a display on figure appears with that search. The Second Trader then clicked on the hyperlink “the american heritage dictionary” 2 which brings to FIG. 5, a display of the detailed message. The Second Trade decides to trade click on “trade” 1 then an email, message, or by communication means sent to the First Trader. The First Trader will reply via FIG. 4, he or she enters the value 1 and press submit 2 an email, message, or by communication means sent to Second Trader. Both the First Trader and Second Trader accepted the value to deposit into the Deposit Bank and delivered the product. Once the First Trader received the product, the First Trader allows the Second Trader to get his or her deposit-amount back also the same in reverse.

FIG. 6 is a front view of an example of an ad detailing the invention of a system and method that provides trading of monetary, goods, or services according to the present invention.

The present example comprise of an ad with description offered and wanted. The First Trader posted this ad. The Second Trader replies to this ad. Both the First Trader and the Second Trader deposit $10 value 1 to the owner of the newspaper or parties allowed by the owner for Deposit Bank. Then the First Trader sends the product out once the Second Trader received the product he or she contacts the owner of the Deposit Bank to send $10 dollars back to the First Trader and vice versa.

FIG. 7 is a front view of an example of a system and method that provides trading of monetary, goods, or services according to the present invention.

The present example comprise of a front-page FIG. 7. A merchant 1 offers shoes for sale posted on the system 3. The buyer 2 comes across the posting and like to purchase the shoes. The buyer 2 requests a deposit from the merchant 1 of $4 dollars in the Deposit Bank 4. On the other hand the merchant 1 request a deposit of $0 dollars from the buyer 2, so both deposits on to the Deposit Bank. So the merchant 1 sends out the product and the buyer 2 sends out the monetary payment. Once the monetary and product was received on both sides. The deposit monetary is returned to both sides from the Deposit Bank 4.

### DESCRIPTION OF THE PREFERRED EMBODIMENT

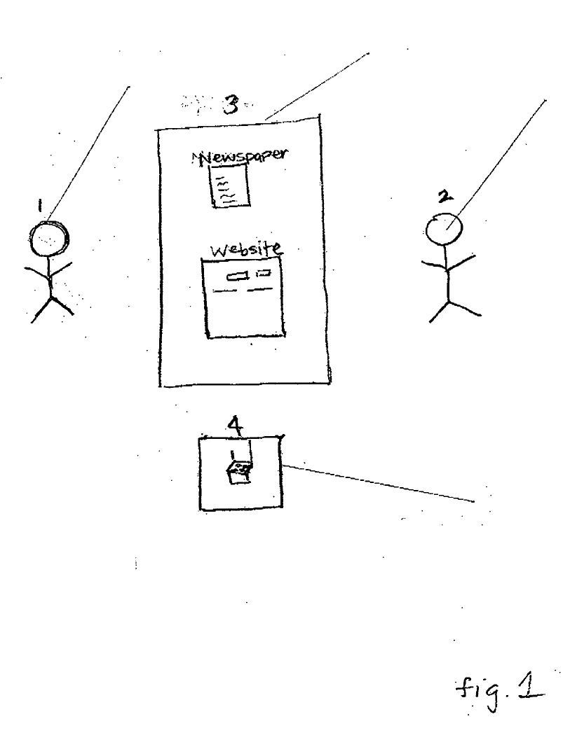

FIG. 1 is a front view of a System 16 and method that provides trading of goods and services according to the present invention.

The present invention generally comprises of any System 16 electronic or paper 3 where by a person, First Trader 10, willing to post “monetary, goods, or services” they would provide for another person, Second Trader 12, “monetary, goods, or services”. The First Trader 10 would post his, her, or entity monetary, goods, or services and also post his, her, or entity wanted monetary, goods or services in exchange for on System 16. The Second Trader 12 who visits this electronic or ad, local or international, System 16 finds the posting, will post a reply to this post and say yes he, she, or entity have the monetary, goods, or services wanted. The First Trader 10 then replies to this message if he, she, or entity agrees for a trade. Then Second Trader 12 will choose a value for the goods or services as a deposit to the Deposit Bank 14. The Second Trader 12 then deposits the monetary and the First Trader 10 also deposit the monetary in form of check, money order, credit card, or any valid payment type to Deposit Bank 14. Once the monetary value is received or holds from both ends. The Second Trader 12 shipped or delivers his, her, or entity “monetary, goods, or services” out to the First Trader 10. Also the First Trader 10 ships or delivers his, her, or monetary goods or services to the Second Trader 12. The monetary deposited is return from the Deposit Bank 14 to both traders 1 and 2. Transaction fees and shipping may or may not apply.

It will also be understood that, in addition, system and method provides for trading of monetary, goods, or services, the system can be used for multiple traders that is a Third Trader who wants the monetary, goods, or services from the First Trader. Whereas the First Trader gets to choose a Trader from the list of Traders (Second, Third, Fourth, etc. Trader).

It will also be understood that, in addition, system and method provides for trading of monetary, goods, or services, the system can be used on any communication such as radio stations or/and TV programs.

It will also be understood that, in addition system and method provides for trading of monetary, goods, or services, the system can be used as a First Trader who wants to trade his or her goods or services plus monetary value for Second Trader goods or services. Or Second Trader wants to trade goods or services plus monetary value for First Trader goods or services.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A system and method that provides for trading monetary, goods, or services, comprising: means for deposit and delivering monetary, goods, or services;
means for deposit or delivering monetary, goods, or services;
means for depositing monetary funds into and release the deposited monetary funds, rigidly connected to said means for deposit or delivering monetary, goods, or services, and rigidly connected to said means for deposit and delivering monetary, goods, or services; and
means for advertise or post an ad, rigidly connected to said means for deposit or delivering monetary, goods, or services, and rigidly connected to said means for deposit and delivering monetary, goods, or services.

2. The system and method that provides in accordance with claim 1, wherein said means for deposit and delivering monetary, goods, or services comprises a person or entity, variable value deposit, deposit value could zero, consent First Trader.

3. The system and method that provides in accordance with claim 1, wherein said means for deposit or delivering monetary, goods, or services comprises a person or entity, variable value deposit, deposit value could be zero, consent Second Trader.

4. The system and method that provides in accordance with claim 1, wherein said means for depositing monetary funds into and release the deposited monetary funds comprises the owner of the system or third parties, hold or receive funds, a place, account, bank, or the like Deposit Bank.

5. The system and method that provides in accordance with claim 1, wherein said means for advertise or post an ad comprises a website, newspaper or communication system.

6. A system and method that provides for trading monetary, goods, or services, comprising: a person or entity, variable value deposit, deposit value could zero, consent First Trader, for deposit and delivering monetary, goods, or services;
a person or entity, variable value deposit, deposit value could be zero, consent Second Trader, for deposit or delivering monetary, goods, or services;
the owner of the system or third parties, hold or receive funds, a place, account, bank, or the like Deposit Bank, for depositing monetary funds into and release the deposited monetary funds, rigidly connected to said Second Trader, and rigidly connected to said First Trader; and
a website, newspaper or communication system, for advertise or post an ad, rigidly connected to said Second Trader, and rigidly connected to said First Trader.

7. A system and method that provides for trading monetary, goods, or services, comprising: a person or entity, variable value deposit, deposit value could zero, consent First Trader; for deposit and delivering monetary, goods, or services;
a person or entity, variable value deposit, deposit value could be zero, consent Second Trader, for deposit or delivering monetary, goods, or services;
the owner of the system or third parties, hold or receive funds, a place, account, bank, or the like Deposit Bank, for depositing monetary funds into and release the deposited monetary funds, rigidly connected to said Second Trader, and rigidly connected to said First Trader; and
a website, newspaper or communication system, for advertise or post an ad, rigidly connected to said Second Trader, and rigidly connected to said First Trader.
